(19) United States
(12) Patent Application Publication
(10) Pub. No.: US 2010/0229222 A1
(43) Pub. Date: Sep. 9, 2010

(54) Peer-to-Peer Video Content Distribution Network Based on Personal Network Storage

(75) Inventors: Jun Li, Plainsboro, NJ (US); Snigdha Verma, Karnataka (IN); Kumar Ramaswamy, Princeton, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/223,881

(22) PCT Filed: Feb. 21, 2006
(86) PCT No.: PCT/US2006/006101

§ 371 Date: Aug. 12, 2008

(51) Int. Cl. G06F 15/16; H04L 9/32; G06F 21/00

(52) U.S. Cl. 726/5; 709/219; 709/217

(57) ABSTRACT

A method and system of accessing content in a peer-to-peer network are described including receiving by a peer a content list including content availability from a directory service, requesting content from the directory service and downloading the requested content to a first personal network storage area associated with the requesting peer from a second personal network storage area associated with a second peer, wherein the first and second personal network storage areas are hosted by servers with an access network. A method and system for accessing content in a peer-to-peer network are also described including receiving by a directory service peer information and content availability information, posting the peer information and the content availability information, receiving a request for content from a peer and directing a personal network server having a personal network storage areas associated with peers to transfer the content from a personal network storage area associated with a second peer to a personal network storage area associated with the requesting peer.

### FIELD OF THE INVENTION

The present invention relates to networking and in particular to the distribution of video services over a peer-to-peer content distribution network.

### BACKGROUND OF THE INVENTION

In recent years, Peer-t-Peer (P2P) content distribution has had a significant impact on the media and entertainment industry because of its simplicity and low cost of deployment and operation.

The idea of P2P content distribution is to utilize the customers' computers as peers to form a network, so that the content can be stored and distributed using customer resources. The service provider only coordinates the content distribution with a lower investment and maintenance cost.

There are two major problems for the P2P approach to be used in broadband home network, especially for large size, high-value video content. The first problem is that of content protection to prevent unauthorized distribution while simultaneously guaranteeing the management of individual rights to purchased content according to agreed upon rules. Content owners may be reluctant to permit their valuable content to be stored on consumers' computers. Content stored on consumers' computers can be much more easily duplicated or transferred to other devices. The second problem is the uplink bottleneck problem. A P2P approach generates symmetric network traffic load between consumer devices and the access network. As shown in FIG. 1, the uplink traffic load is the sum of file-A and file-B from peer-2 and peer-3, which is the same as the downlink traffic load to peer-1. When a P2P service is provided, the overall traffic load to/from the access network must be balanced (symmetric traffic load). However, the capacity of the access network is not balanced (asymmetric capacity) with respect to uplink and downlink traffic loads. For both cable and DSL networks, because they are designed to support Internet access for web downloading/streaming applications, the ratio of the downlink capacity to the uplink capacity can be very large, for example 10:1 or greater. Due to the large size of video content, the uplink capacity of the access network can be easily overloaded by a P2P service solution.

### SUMMARY OF THE INVENTION

In the present invention, P2P distribution techniques for exchanging content between peer storage devices residing within the access network (referred to as personal network storage system). The personal network storage system has designated storage areas within the access network dedicated to individual subscribers. The invention takes advantage of existing P2P distribution algorithms while simultaneously avoiding the uplink bottleneck problem.

The personal network storage system can be a service provided by the access network provider. For example, the network PVR is a form of personal network storage. Since the personal network storage units logically belong to the peering computers, they are transparent to the P2P content distribution network solution. Thus, the same simplicity and operation of a P2P content distribution network can be achieved.

A P2P content distribution network with personal network storage units has advantages over conventional P2P content distribution network solutions, including: (1) avoidance of the uplink bottleneck; (2) content being available even if peering computers are turned off; (3) more choices on content protection; and (4) low-cost peering devices, especially when a set-top box (STB) is used. In addition, the network service operator may have a more predictable way to detect the presence of priated content within their network since they have more regulated access to the stored content in the network storage system.

Convention P2P content distribution network solutions are used for music and/or small data file downloading, which requires little bandwidth compared with downloading a video file. A standard definition (SD) DVD file is greater than 4 GB and the real-time streaming rate for such a file can be as high as 11 Mbps. It is very slow to download or stream the file. Even if the downlink capacity is high enough, the speed will be restricted by the uplink capacity, which is usually much less than the downlink capacity.

A method and system of accessing content in a peer-to-peer network, are described including receiving, by a peer, a content list including content availability from a directory service, requesting, by the peer, content from the directory service; and downloading the requested content to a first personal network storage area associated with the requesting peer from a second personal network storage area associated with a second peer, wherein the first and second personal network storage areas are hosted by servers within an access network. Also described are a method and system for accessing content in a peer-to-peer network, including receiving, by a directory service, peer information and content availability information, posting, by the directory service, the peer information and the content availability information, receiving, by the directory service, a request for content from a peer and directing a personal network server having a personal network storage areas associated with peers to transfer the content from a personal network storage area associated with a second peer to a personal network storage area associated with the requesting peer.

### BRIEF DESCRIPTION OF THE DRAWINGS

The present invention is best understood from the following detailed description when read in conjunction with the accompanying drawings. The drawings include the following figures briefly described below where like-numbers on'the figures represent similar elements:

FIG. 1 is a schematic diagram illustrating the uplink bottleneck problem in a conventional peer-to-peer content distribution network.

FIG. 2 is a schematic diagram of personal network storage based P2P content distribution network in accordance with the principles of the present invention.

FIG. 3 is a flowchart of the operation of a personal network storage based P2P video content distribution network in accordance with the principles of the present invention.

### DETAILED DESCRIPTION OF THE PREFERRED EMBODIMENTS

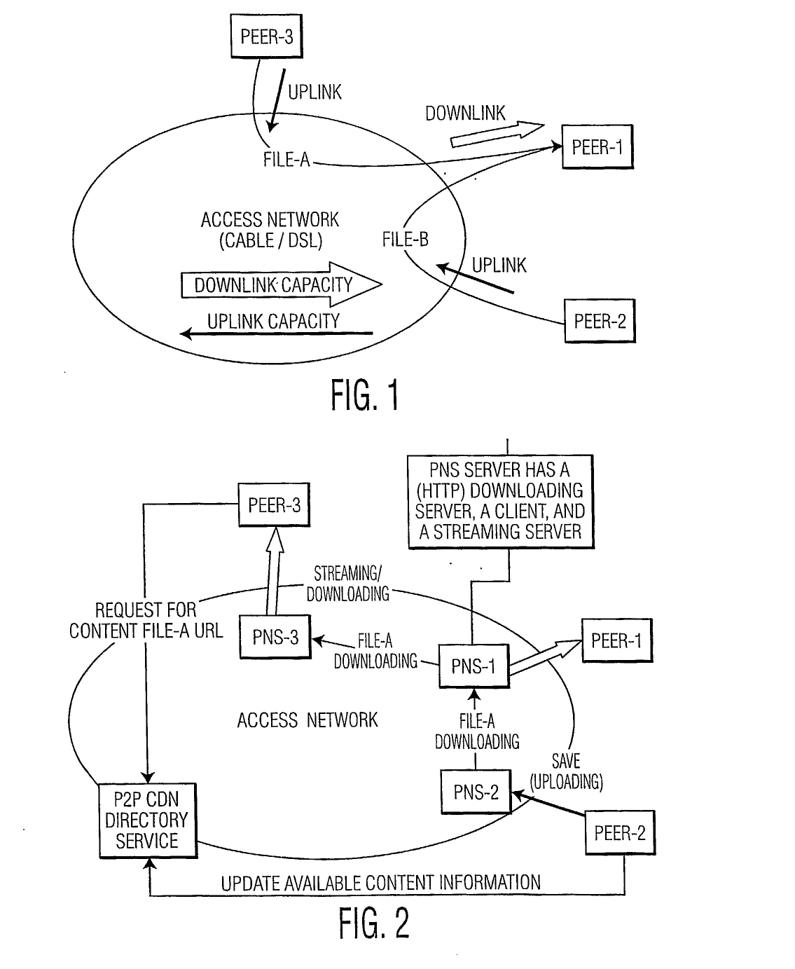

Some P2P solutions have attempted to solve the uplink bottleneck problem by striping the contents into segments, so that each unit of content can be hosted at multiple peers. Pieces of content can be downloaded to a peer simultaneously from multiple peers at a combined rate of multiple uplink capacities. For example, in FIG. 1, if file-A and file-B are two parts of a unit of content, the downloading rate to peer-1 is restricted by the combined uplink capacities of peer-2 and peer-3, which can be a rate of twice as much as the maximum uplink capacity. Downloading content simultaneously from more than one peer itself does not boost overall uplink capacity, neither does it reduce the overall uplink traffic load unless the two uploading peers are in different physical networks. In 2P service for large size content, such as video, the uplink can be easily overloaded.

Personal network storage systems such as network personal video recorders (PVRs) have been used by cable companies having client-server architectures to allow customers to record TV programs without more expensive set-top boxes with storage. For example, an on-line picture album is a personal network storage system for a customer to store their photographs so that others can browse them at their convenience.

The present invention uses personal network storage for video content distribution in a P2P content distribution network. In other words, P2P protocols are employed among peering computers but the storage units are within the access networks. This solves the uplink bottleneck problem and provides flexible access capability. P2P network can be wired or wireless.

The present invention includes a P2P content distribution network solution, which includes a personal network storage (PNS) system (defined as a network drive served by a server inside the access network) and a server for performing uploading, downloading and/or streaming functions.

A content service provider can build a P2P content distribution network for peers with personal network storage. Since PNS units are considered network drives, they are transparent to P2P content distribution network protocols. The P2P protocol is kept among peering computers although the actual content distribution is among PNS units within the access network.

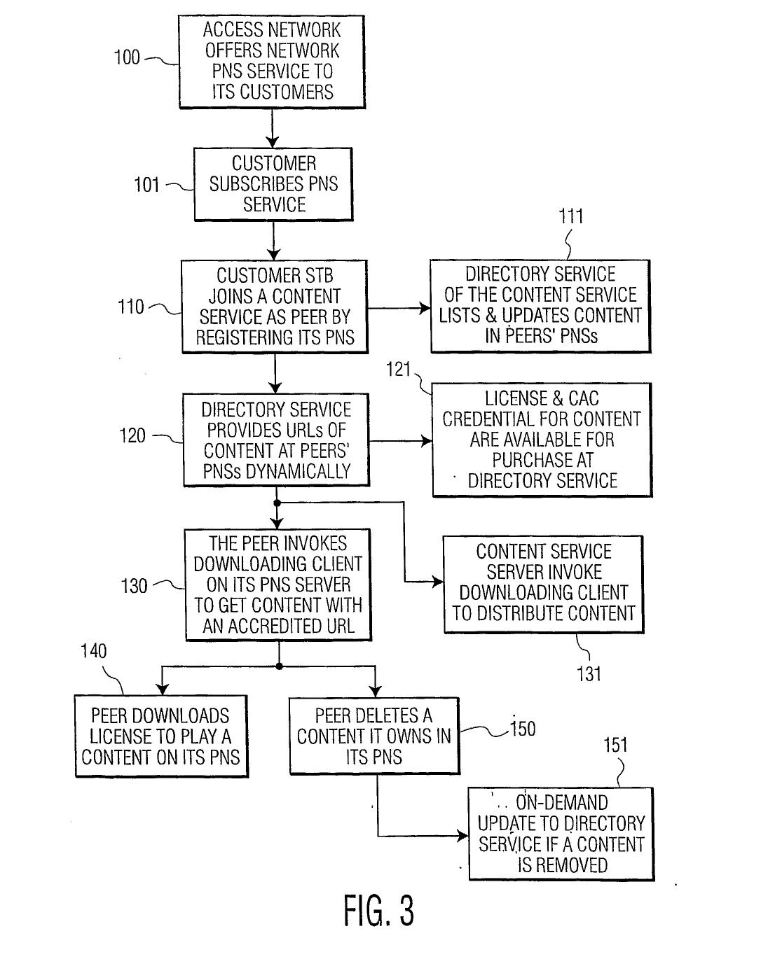

A PNS unit is a network drive, which is shared with read access roghts for all peers and write access rights for at least one owner. As shown in FIG. 2, file-A can be downloaded from PNS-1 to PNS-3. Although the action is initiated by peer-3, the data transfer is directly between servers hosting PNS-1 and PNS-3 without going through peer-3′s network interface. Optionally, the action can be initiated by a third party without going through either peer-3 and/or peer-1's network interfaces. For example, the third party can be the peer where the content service provider is located/hosted. If the peer hosting the content service provider has the write access rights, it can directly manage the content distribution without involving peers if necessary and appropriate.

Specifically, with reference to FIG. 2, the P2P content distribution network directory service continually updates information it has about each peer and about content availability (content associated with a peer and available on a PNS unit). For Example, peer-2 provides the directory service with updated content availability. When peer-3 requests file_A, file-A is transferred between servers hosting PNS-1 and PNS-3 and subsequently streamed to peer-3 from PNS-3.

A peer requests and receives a content list including availability from a directory service of an access network via, for example, a universal resource locator access protocol. A peer then requests content via the directory service. The content is then downloaded not between peers but rather between personal network storage areas/units associated with peers. That is, between the personal network storage area of peers having the content and peers requesting the content. The directory service and downloading are performed via an access protocol, for example, a universal resource locator access protocol.

Normally, when a peer attempts to download a content file via an access protocol to a drive, for example drive E, even if drive E is a network drive, the content file is first downloaded into the network interface via the access protocol into the network and then goes out again through the network interface to drive E in the network. The P2P downloading program on the local computer needs to avoid traffic going back and forth through its network interface. When the destination is on the personal network storage system, this program must invoke a downloading program on the server hosting its network drive to directly download the content file to the personal network storage system.

In an exemplary embodiment, the peer's personal network storage servers execute HTTP server and client programs. When a peer tries to download a content file via an access protocol to its network drive (for example, drive E), the P2P downloading program is executed. This invokes a server side program at the HTTP server on its personal network storage server. The server side program, for example, a computer generated interface (cgi) program, causes the content to be downloaded via the access protocol and saves the content to the directory corresponding to the network drive (e.g., drive E) for the peer. Read and write access rights for the personal network storage system can be implemented by, for example, HTTP access control mechanisms.

In another exemplary embodiment, the peers' personal network storage servers run a file transfer protocol (ftp) server and client programs. The P2P downloading program invokes the ftp client on the destination server and downloads the content file from the source that runs an ftp server.

Specifically, with reference to FIG. 3, at 100, personal network storage service is offered to customers/users of an access network. A customer/user subscribes to the personal network storage service at 101. A customer's set-top box joins a content service as a peer by registering its personal network storage with the P2P content distribution network at 110. Based on information provided by customers'/users' set-top boxes, the directory service of the P2P content distribution network continually lists and updates content available in each peer's personal network storage at 111. The directory service of the P2P content distribution network, therefore, provides access protocols (for example, universal resource locator access protocols) of content at peers' personal network storage areas/units dynamically at 120. Licenses and content access control credentials are available for customers/users to purchase from the directory service of the P2P content distribution network at 121. A peer invokes downloading a unit of content onto its personal network storage area/unit via an accredited URL (web site) at 130. The content service server downloads the requested content at 131. A peer needs to have a license to play/view content stored on its personal network storage unit and purchases license(s) to do so at 140. A peer can also delete/clear content from its personal network storage area at 150. Any deleted content causes the directory service to be updated at 151. It is important to note that content may be available immediately or on a delayed basis.

In a personal network storage based P2P content distribution network, while content striping is not necessary to address either content distribution or uplink bottleneck problems, a content service provider may still want to stripe content for other reasons such as improving speed. If the content is striped across a plurality of storage devices then the requester/recipient may be able to get the content faster because the content can be retrieved in parallel.

Once the content is stored and managed physically inside the access network, through access control and other techniques, such as client-based re-encoding, more content protection choices are available.

It is to be understood that the present invention may be implemented in various forms of hardware, software, firmware, special purpose processors, or a combination thereof, for example, within a mobile terminal, access point, or a cellular network. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method of accessing content in a peer-to-peer network, said method comprising:
receiving, by a peer, a content list including content availability from a directory service;
requesting, by said peer, content from said directory service; and
receiving said requested content at a first personal network storage area associated with said requesting peer from a second personal network storage area associated with a second peer.

2. The method according to claim 1, further comprising providing content availability information and peer information to and on said directory service.

3. The method according to claim 1, wherein said content list is accessed via an access protocol, and further wherein said first and second personal network storage areas are hosted by servers within an access network.

4. The method according to claim 1, wherein said content request is accompanied by a license purchase from said directory service and control access credentials provided by said directory service.

5. The method according to claim 1, wherein said second receiving act is invoked remotely by said requesting peer.

6. The method according to claim 1, wherein said second receiving act is via an access protocol.

7. The method according to claim 1, wherein said second receiving act is delayed.

8. The method according to claim 1, wherein said peer-to-peer network is a wireless network.

9. The method according to claim 1, further comprising deleting content from said associated personal network storage device by one of said requesting peer and said second peer.

10. The method according to claim 1, further comprising updating content from said associated personal network storage device by one of said requesting peer and said second peer.

11. A system of accessing content in a peer-to-peer network, comprising:
means for receiving, by a peer, a content list including content availability from a directory service;
means for requesting, by said peer, content from said directory service; and
means for receiving said requested content to at a first personal network storage area associated with said requesting peer from a second personal network storage area associated with a second peer.

12. The system according to claim 11, further comprising means for providing content availability information and peer information to and on said directory service.

13. The system according to claim 11, wherein said content list is accessed via an access protocol and further wherein said personal network storage areas are hosted by servers within an access network.

14. The system according to claim 11, wherein said content request is accompanied by a license purchase from said directory service and control access credentials provided by said directory service.

15. The system according to claim 11, wherein said second receiving act is invoked remotely by said requesting peer.

16. The system according to claim 11, wherein said second receiving act is via an access protocol.

17. The system according to claim 11, wherein said second receiving act is delayed.

18. The system according to claim 11, wherein said peer-to-peer network is a wireless network.

19. The system according to claim 11, further comprising means for deleting content from said associated personal network storage device by one of said requesting peer and said second peer.

20. The system according to claim 11, further comprising means for updating content from said associated personal network storage device by one of said requesting peer and said second peer.

21. The system according to clam claim 1, wherein said servers are network devices.

22. A method for accessing content in a peer-to-peer network, said method comprising:
receiving, by a directory service, peer information and content availability information;
posting, by said directory service, said peer information and said content availability information;
receiving, by said directory service, a request for content from a peer; and
directing a personal network server having a personal network storage areas associated with peers to transfer said content from a personal network storage area associated with a second peer to a personal network storage area associated with said requesting peer.

23. The method according to claim 22, wherein said directory service is hosted by a server within an access network.

24. The method according to claim 22, wherein said directory service is hosted by a peer within said peer-to-peer network.

25. The method according to claim 22, wherein said content request is accompanied by a license purchase from said directory service and control access credentials provided by said directory service.

26. The method according to claim 22, wherein said transferring is delayed.

27. The method according to claim 22, wherein said peer-to-peer network is a wireless network.

28. A system for accessing content in a peer-to-peer network, comprising:
means for receiving, by a directory service, peer information and content availability information;
means for posting, by said directory service, said peer information and said content availability information;
means for receiving, by said directory service, a request for content from a peer; and
means for directing a personal network server having a personal network storage areas associated with peers to transfer said content to a personal network storage area associated with said requesting peer from a personal network storage area associated with a second peer.

29. The system according to claim 28, wherein said directory service is hosted by a server within an access network.

30. The system according to claim 28, wherein said directory service is hosted by a peer within said peer-to-peer network.

31. The system according to claim 28, wherein said content request is accompanied by a license purchase from said directory service and control access credentials provided by said directory service.

32. The system according to claim 28, wherein said transferring is delayed.

33. The system according to claim 28, wherein said peer-to-peer network is a wireless network.

34. The method according to claim 22, further comprising invoking a downloading program on said server hosting said second personal network storage area to automatically transfer said requested content.

35. The system according to claim 28, further comprising means for invoking a downloading program on said server hosting said second personal network storage area to automatically transfer said requested content.
